(19) United States
(12) Patent Application Publication
(10) Pub. No.: US 2002/0096639 A1
(43) Pub. Date: Jul. 25, 2002

(54) Charges circuit reading by calibration and charge reading procedure by calibration

(75) Inventors: Patrick Audebert, Varces (FR); Philippe Pantigny, Claix (FR); Eric Mottin, St Martin Le Vinaux (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: COMMISSARIAT A L'ENERGIE ATOMIQUE, Paris (FR)

(21) Appl. No.: 09/990,336

(22) Filed: Nov. 23, 2001

(30) Foreign Application Priority Data
Dec. 7, 2000 (FR) 00 15899

(51) Int. Cl. G01T 1/24

(52) U.S. Cl. 250/370.08

(57) ABSTRACT

The invention concerns a charges circuit reader containing charges storage material (Tc), charges addressing (Ta) and charges/voltage conversion material (Aj) including a conversion capacity, addressing material enabling control of the supply, in the conversion material, of stored charges in the storage material. The circuit includes calibration material (Tccal, Tacal, Il, Ccal) to deliver representative information (Vs) of the charges stored in the stored material and material (K, I2) to select the conversion capacity from the said information.

The invention applies to the reading of charges derived from the detection of infrared, visible or X rays wavelength radiation.

### TECHNICAL FIELD AND PREVIOUS TECHNIQUE

The invention concerns a charges circuit reading as well as a charges reading procedure.

More particularly, the invention concerns a charges reading device derived from the detection of radiation by a matrix of N×M elementary detectors as well as a charges reading procedure implemented by such a reading device.

The radiation detected can be, for example, infrared, visible or X rays wavelength radiation. The reading of a detector circuit put together in the form of a matrix of N lines by M columns of elementary detectors is done by scanning, line by line or column by column.

FIG. 1 represents a radiation detection device according to the previous article.

The detection device includes N×M ij elementary detectors (I=1, . . . , N; j=1, . . . , M), N×M Pj elementary points, M BCj bus column, M Aj charges amplifiers and a MX multiplexing circuit. Each Pij elementary point includes a Tp transistor to adapt the impedance of the ij elementary detector to the reading circuit, a Tc integration transistor and an addressing Ta transistor.

The ij detector is, for example, an N type photovoltaic detector on P substrate. The Tp transistor is a NMOS transistor mounted on a common grid and whose source and drain are respectively connected to the detector and to the source of the Tc integration NMOS transistor.

This type pf circuit reading architecture is commonly designated by SCA type architecture (SCA=“Snapshot Charge Amplifier”).

A HP clock signal applied to the grid of all the Tp transistors defines the shot time.

The integration function is here implemented by Tc NMOS transistor whose source and drain are linked on the one hand to the Tp transistor drain and on the other hand to the Ta addressing NMOS transistor entry diode. In some cases the source and the Tc drain can be short-circuited.

The same Hci clock signal (I=1, . . . , N) is applied on the grid of all the Tc transistors on one line. Each line of the circuit reading is attacked by a different Hci signal clock.

The Ta addressing NMOS transistor is mounted on a switch between the drain of the Tc transistor and the connection to the Bcj bus column.

The same Hai clock signal (I=1, . . . , N) is applied on the grid of Ta transistors of the same line. Each circuit reading line is attacked by a different Hai clock signal.

The Aj charges amplifier (j=1, . . . , M) contains an AC differential amplifier, a Ca condenser and a Tr transistor.

The BCj bus column links the Pij elementary point exit of the same column to the reverse entry of the AC differential amplifier whose non-reverse entry is linked to a Vref supply.

The Ca capacity and the Tr transistor are mounted in parallel between the reverse entry and the exit of the AC differential amplifier. The Tr transistor is used as a switch to reinitialise the Ca capacity between the readings of two consecutive lines. The Tr transistor grid is guided by a HR clock signal. A Vj voltage is gathered at the exit of the AC differential amplifier.

The charges packet of the Pij elementary points of the same row I line are simultaneously converted in voltage by all the Aj charges amplifiers placed at the edge of the bus columns.

The Vj voltages gathered at the exit of the charges amplifiers are applied on the different entries of a multiplexer in MX voltage to M entries and an exit. The Vs voltage gathered at the exit of the MX multiplexer thus takes as a value the successive values of Vj voltages (j=1, . . . , M).

When charges-voltage conversion relating to a line of detectors has been made the charges amplifiers are reinitialised so as to enable the charges-voltage conversion of the following line.

An inconvenient factor of a structure such as the one described above is that it generates a high level of noise.

Where there is white noise, the present charges amplifier, with frequencies located in its transmission band, has an amplification factor relating to its intrinsic noise voltage that is given by the following formula:

G=((Cin+Ca)/Ca)½ where

Cin is a parasite capacity brought to the reverse entry of the charges amplifier and Ca is the conversion capacity of the charges/voltage conversion amplifier.

The Cin parasite capacity is proportional to the number of lines of the matrix of detectors as well as to the step that separates two detectors of the same line and the Ca capacity is linked to the maximum charge that can be integrated in an elementary point. In addition the functioning current of the charges amplifiers is limited by the consumption imposed on the circuit.

It follows that the noise level of the reading circuit is a function of parameters imposed by the technical specifications. This is particularly the case with highly complex components (for example containing 640×480 elementary points) for which the power dissipated by the charges amplifiers is one of the main sources of consumption. It is therefore not possible, according to the known technique to produce large format reading devices that have good noise performance.

It thus appears that the highly complex SCA type architectures are limited in noise performance. These limitations are, in addition, amplified for applications that have a high scene dynamic to process as is indicated below as an example for a quantal image

sensor produced from hybrid HgCdTe photodiodes on a CMOS circuit and meeting the following technical specifications:

maximum photonic current:

$$I {\underline{max}}_{ph} = 2 Na$$

duration of the image shot:

Ti=1mS

equivalent rms noise voltage brought to entry of the charges amplifier:

ea=80 μV rms

parasite capacity of bus column (parasite capacity view on reverse entry of the amplifier):

Cin=4pF

maximum exit excursion of the charges amplifier: vsmax=2V

For such an image sensor the maximum charge that it is possible to store in an elementary image point is:

$$\begin{matrix}Q Max = & I Max \times Ti = 2 pC \\ PEL & ph \end{matrix}$$

The capacity of the charges-voltage conversion condenser of the charges amplifier can be written as follows:

$${C}_{a} = \frac{Q \begin{matrix}Max \\ PEL\end{matrix}}{Δ {Vs}^{Max}} = 1 p F$$

The es equivalent noise at the exit of the charges amplifier is written as follows:

Es=G×ea

Where G is the amplification factor mentioned above.

The following thus applies:

Es 180 μV rms

Generally in quantal sensors the processing chain degrading by a 2 factor the noise performances of detectors under minimum flux is tolerated. That means that the noise associated with the reading circuit is at the most equal to the noise associated with the detector under minimum lighting conditions.

Where there are photovoltaic detectors that only have a Schottky noise source the following applies:

$${e}_{s} = √ \frac{{I}_{ph}^{min} \times Ti}{q} \times \frac{q}{{C}_{a}}$$

Where Imin is the minimum detectable photonic current

Therefore:

$${I}_{ph}^{min} = \frac{{( {e}_{s} \times {C}_{a} )}^{2}}{q \times Ti}$$

$${I}_{ph}^{min} = 200 p A .$$

Ie here:

The maximum dynamic of intensity that the reading circuit is capable of processing is thus:

$$D = \frac{{I}_{ph}^{Max}}{{I}_{ph}^{min}} \# 10$$

In certain applications this dynamic is not sufficient. For very varied scenes for example, a dynamic of 100 may be necessary.

In addition according to current technique the Volt/coulomb response of the reading circuit is the same f or all the elementary points. This response is therefore a weak value for elementary points whose detected charge has a weak quantity. This is the case particularly for images under reduced incident flux when it is not possible to increase the integration time (image rate problem and/or moved during shooting). This is also the case when the imaged scene presents a significant contrast: detected charge near saturation for certain photodiodes and much lower than saturation for others. A weak value response in Volt/Coulomb is manifested by a greater sensitivity relative to the shift of the quiescent point of the multiplexing chain (column exit to video exit) and a lesser immunity to noises (stray coupling) on the video signal.

The invention does not present the drawbacks mentioned above.

Indeed the invention concerns a charges reading circuit containing charges storage material, charges addressing material and charges/voltage conversion including a capacity conversion, addressing material enabling injection control, in the conversion material, charges stored in the storage equipment. The circuit contains calibration material to deliver representative information of the stored charges in the storage material and material for selecting the conversion capacity from the said information.

The invention also concerns a reading device for charges derived from the detection of radiation by a matrix of N lines by M columns of elementary detectors, reading device including a total of N×M elementary points and charges/voltage conversion material, each elementary point being linked to an elementary detector and including storage material to store the charges detected by the elementary detector to which it is linked and addressing material to control the injection in the conversion material, charges stored in the storage material, the conversion material containing a conversion capacity. The device is characterised by the fact that an elementary point includes calibration storage material to stock a fraction of the stored charges in storage material and at least one addressing material to control the injection in the conversion equipment, stored charges in the calibration storage material and in the fact that the conversion material includes a first calibration capacity to convert the addressed charges coming from the calibration storage material in a calibration voltage and material to select the conversion capacity from the calibration voltage.

The invention also concerns a charges reading process including successively a charges storage stage, a charges addressing stage and a charges/voltage conversion stage, the addressing stage enabling control of the injection in charges/voltage conversion equipment including a conversion capacity, charges stored during the storage stage. The process includes a calibration stage to deliver information representative of the stored charges during the storage stage and a selection stage of the conversion capacity from the said information.

The invention also concerns a reading process for charges derived from the detection of radiation by a matrix of N lines by M columns of elementary detectors, the process including a reading stage of charges detected by each elementary detector. The reading stage of the charges detected by each elementary detector is done by a reading process like the process according to the invention mentioned above.

### BRIEF DESCRIPTION OF THE FIGURES

Other characteristics and advantages of the invention will appear on reading a preferential mode of production of the invention done in reference to the appended figures among which:

FIG. 1 represents a SCA type charges reading device according to the previous kind

FIG. 2 represents an SCA type charges reading device according to the invention

FIG. 3 represents a perfecting if the SCA type charges reading device according to the invention

### DETAILED DESCRIPTION OF THE IMPLEMENTATION MODE OF THE INVENTION

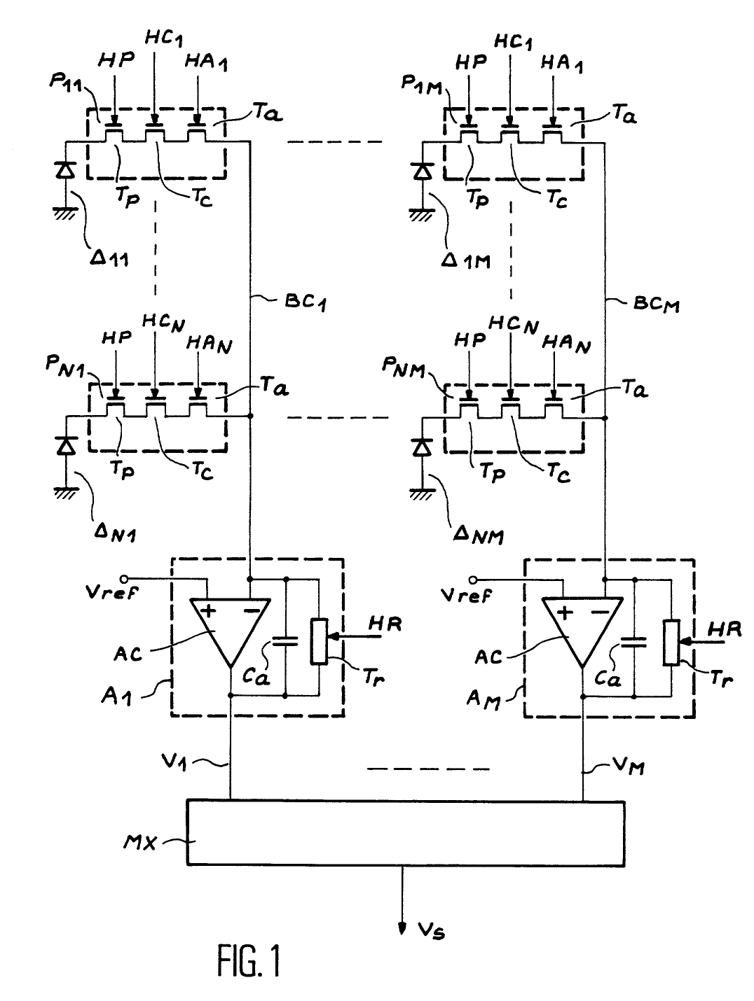

FIG. 1 has been previously described. There is therefore no point returning to it.

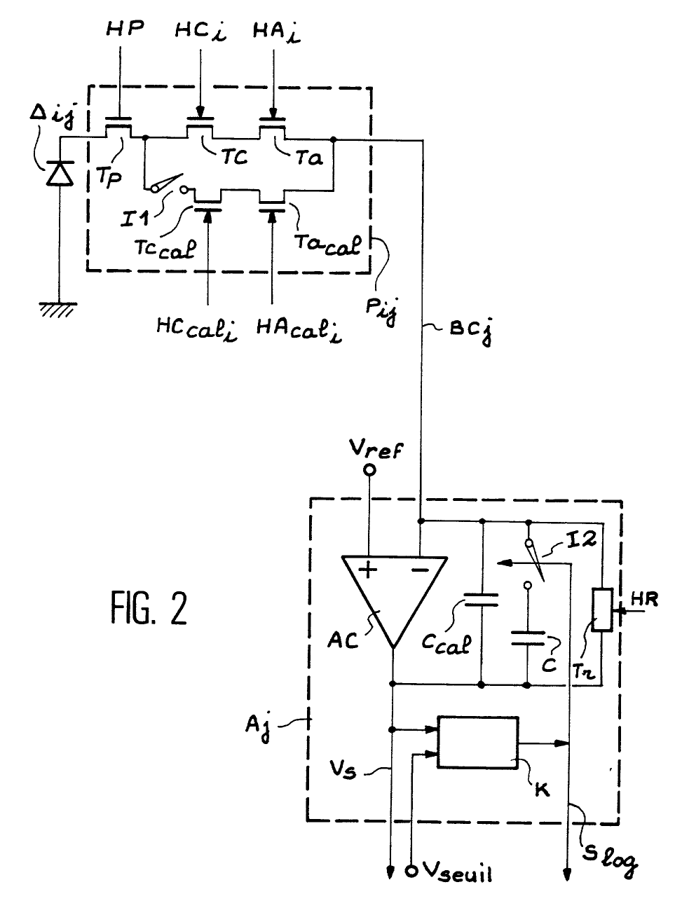

FIG. 2 represents a charges reading device according to the invention. For reasons of simplicity only an elementary detector made up of a ij diode and a Pij elementary point, a BCj bus column and a Aj charge amplifier are represented on FIG. 2. Generally, the invention nevertheless concerns a reading device structured in the form of a matrix containing M×N elementary detectors.

An elementary point according to the invention includes as well as the Tp, Tc and Ta transistors at least one extra circuit mounted in parallel to the Tc and Ta transistors and made up of a Il switch and two extra Tccal and Tacal transistors.

A charges amplifier according to the invention includes a K comparer, an AC differential amplifier, a Ccal conversion capacity mounted between the exit and reverse entry of the AC differential amplifier and at least one extra circuit mounted in parallel to the Ccal capacity and made up of a I2 switch and C supplementary conversion capacity. A Tr transistor whose grid is guided by HR clock signal is used as a switch to reinitialise the integration capacity.

As a non-limiting example the elementary point illustrated in FIG. 2 only contains a single supplementary circuit mounted in parallel to the Tc and Ta transistors and the charges amplifier only includes a single supplementary circuit mounted in parallel with the Ccal capacity.

When the Il switch is closed the photonic current delivered by the ij diode attacks the channel of the two Tc and Tccal MOS integration transistors. The Il switch enables control of the integration in the Tccal transistor. It prevents the stored charges returning into the TC cal transistor during the elementary point reading. The Ta and Tacal transistors enable control of the injection of the stored charges respectively in the Tc and TC cal transistors according to the SCA principle.

The BCj bus column attacks the reverse entry of the Aj charges amplifier whose non-reverse entry is linked to a Vref reference voltage. The C condenser is connected in parallel of the Ccal connector through the I2 switch. The I2 switch is controlled by a Slog logical comparison signal derived from the K comparator. The Slog signal is issued from the comparison of the Vs tapping in exit of the AC differential amplifier with a Vthreshold threshold voltage.

The shot is done by simultaneous integration of the detected charges in the Tc and Tccal transistors (the Il switch is in closed position). The integration capacity of the Pij elementary point is then the total of the integration capacity presented by the Tc transistor and the integration capacity presented by the Tccal transistor.

Once the shot has been taken the charges reading stored in the elementary point is carried out according to two successive phases.

In a first phase the I2 switch is open, only the Qcal charge stored in the TC cal transistor is injected in the C cal conversion capacity of the Aij amplifier, reinitialised beforehand by Tr. Hccali and Hccali clock signals are then applied on the grids of respectively the Tacal and TC cal transistors to authorize the transfer of the Qcal charges. The ΔV_{conv}^{max} variation of the Vs exit of the Aj amplifier is then given by the formula:

$$Δ {V}_{conv}^{max} = {Q}_{cal} / {C}_{cal} .$$

This voltage variation constitutes a representative measure of the total charge stored in the elementary point. If the voltage variation ΔV_{conv}^{max} carries the Vs voltage to a value higher than the threshold tension Vthreshold, the K comparator delivers a Slog comparison logical signal that controls the closing of the I2 switch. The reverse reaction capacity of the Aj amplifier is then made up of C and Ccal condensers in parallel. In the opposite event the I2 switch is not closed again and only the Ccal condenser remains connected in a reverse reaction.

In a second phase the Hai clock signal applied on the Ta transistor grille authorises the transfer of the stored charges in the TC transistor to the reverse reaction capacity of the Aj amplifier. The charge stored in the Tc transistor is then transferred either to the Ccal capacity only or to the Ccal and C capacities in parallel.

The information available in output of the Aj amplifier is made up of the Vs conversion voltage delivered by the AC differential amplifier and the Slog comparison signal delivered by the K comparator. The Vs signal alone does not allow the value of the stored charge to be recovered. To recover the value of the stored charge the calibre that was used to make the measurement must be known. This calibre is given by the Slog comparison signal. The value of the stored charge is then calculated from the Vs conversion voltage and the Slog comparison signal.

Indeed for the same Vs value you can go back to two charge values (one stored on Ccal the other on Ccal and C) for very different values. This reading mode is applied, line by line, to all the elementary points of the column.

According to the mode of production of the invention described above, two conversion calibres are used for the charges/voltage conversion. In a more general way the invention concerns a charge reading device including at least P conversion calibre, P being a number higher than or equal to 2. The K comparator then works on P-1 levels.

An example of production of reading circuit according to the invention will now be described. The reading circuit includes:

a Tc integration transistor whose value of the integration capacity is equal to 9×Cint/10

a Tcal supplementary integration transistor whose value of integration capacity is equal to Cint/10

a Ccal capacity whose value is equal to Cref/10 and

a C capacity whose capacity value is equal to 9×Cref/10

since the value of Cref is a reference capacity value for example equal to lpF and Cint is the same order of magnitude.

When the Il switch is closed the total integration capacity therefore has Cint as a value. Likewise when the I2 switch is closed the total conversion capacity has Cref as a value.

Let us suppose that the maximum voltage variation at the edges of the total reading capacity is equal to 1 volt and the threshold voltage of the comparator is equal to 0.1 volt.

If the photo-charge integrated in a elementary point develops a voltage variation less than 0.1 volt then the exit voltage of the Aj charge amplifier is equally less than 0.1 volt at the end of the first phase. The I2 switch remains open and the charge stored in the Tc integration transistor is transmitted in the Ccal capacity. The conversion in voltage is thus carried out on a capacitive calibre with a value of Cref/10.

If the photo-charge integrated in an elementary point develops a voltage variation higher than 0.1 volt then the exit of the Aj charge amplifier is also higher than 0.1 volt at the end of the first phase. The I2 switch closes and the charge stored in the Tc integration transistor is transmitted in the Ccal+C capacity. The conversion in voltage is thus made on a capacitive calibre with a value of Cref.

To sum up, if the integrated charge is lower than Cint×0.1 V the response of the Aj amplifier is equal to [Cref/10]-1 Volt/Coulomb and, if the integrated charge is higher than Cint×0.1 V, the response of the Aj amplifier is equal to Cref-1 Volt/Coulomb.

Between the two conversion phases, the charges amplifier can be reinitialised or not, a reinitialisation of the charges amplifier leading to a loss of the Qcal charge.

The presence of a calibre with high-level conversion sensitivity ([Cref/10]-1 Volt/Coulomb) enables the favourable processing of the detection of weak quantities of charges corresponding to a weak photonic current, for example a Iph current less than 200 pA.

Where the calibre of a high-level conversion sensitivity is used, the noise amplification factor in exit of the charges amplifier is written:

G=((Cin+Ccal)/Ccal) ½

All things equal also ( see the digital example above), the ea noise equivalent in exit of the charges amplifier is thus written:

Es=510 Vrms

To good effect, it seems thus that the signal is increased by a factor of 10 [(C+Ccal)/Ccal] while the process chain noise only increases by a factor of 2.8 (510/180).

In the event of photovoltaic detector with only a Schottky noise source, the dynamic limitation that it is possible to process with the high sensitivity calibre is indicated by the following equation:

$${I}_{ph}^{min} = \frac{{( {e}_{S} \times Ccal )}^{2}}{q \times Ti} \qquad ( 3 )$$

It then comes to:

$${I}_{ph}^{min} = 8 PA$$

The maximum dynamic that the reading circuit can process is thus written:

$$D = \frac{{I}_{ph}^{Max}}{{I}_{ph}^{min}} \# 120$$

The high sensitivity calibre thus enables a considerable increase of the processing dynamic of a SCA type architecture.

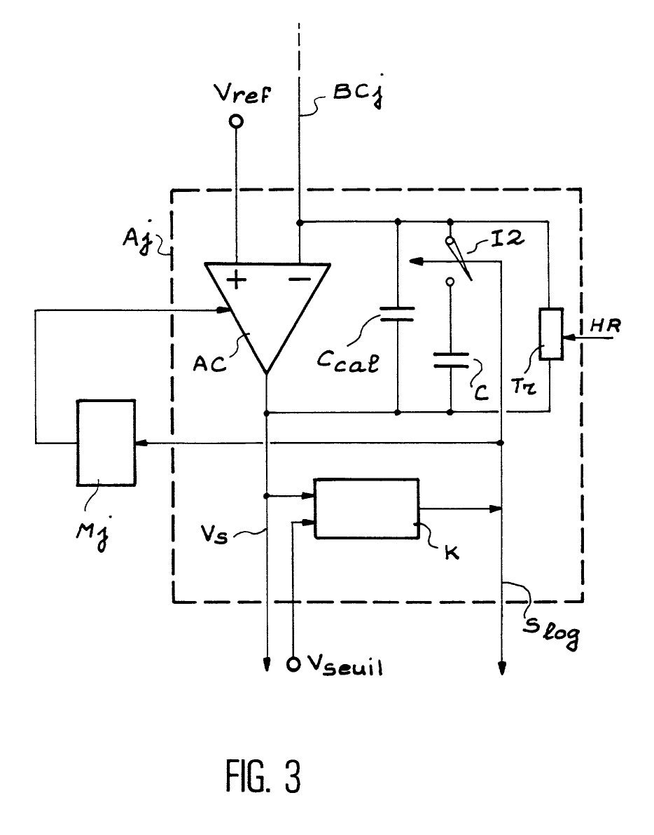

As shown in FIG. 3 according to a perfecting of the invention the Slog logical signal generated during the calibration phase and used to select the calibre of charges/voltage conversion can also be used to adjust the quiescent current of the charges amplifier according to the charges packet to be converted. The reading circuit according to the invention thus includes Mj adjusting material of the quiescent current controlled by the Slog comparison logical signal.

This enables optimisation of the consumption of charges amplifiers of the reading device according to the quantity of charges to be converted.

If the quiescent current of the charges amplifier is fixed at a Il value where the Vs measured during the calibration phase is lower than the Vthreshold voltage it is then possible to bring the quiescent current to a I2 value higher than I1 where the Vs voltage measured during the calibration phase is higher than Vthreshold.

1. Charges reading circuit including charges storage material (Tc), charges addressing material (Ta) and charges/voltage conversion material (Aj) including a conversion capacity, addressing material enabling control of the injection in the conversion material of charges stored in the storage material characterised by the fact that it includes calibration material (Tccal, Tacal, Ii, Ccal) to deliver information (Vs) representative of the charges stored in the storage material and material (K, I2) to select the conversion capacity from the said information.

2. Charges reading circuit according to claim 1 characterised by the fact that the calibration material includes:
calibration storage material (Tccal) to store a fraction of the charges stored in the storage material
calibration addressing material (Tacal) to control the injection in the conversion material (Aj) from the fraction of charges stored in the calibration stored material and
a calibration capacity (Ccal) to convert the addressed charges from the calibration storage material (Tccal) into a calibration voltage and by the fact that the material to select the conversion capacity from the said information includes:
a comparator (K) to deliver a comparison signal (Slog) following the comparison of the calibration voltage with a threshold voltage (Vthreshold) and
at least on switch (I2) controlled by the comparison signal (Slog) to connect at least one supplementary capacity (C) in parallel with the calibration capacity (Ccal) if the calibration voltage is higher than the threshold voltage such that the conversion capacity is made up of the calibration capacity and the supplementary capacity.

3. Charges reading circuit according to claim 2 characterised by the fact that the conversion material includes a differential amplifier (AC) which has a reverse entry and an exit the calibration capacity (Ccal) which was mounted between the reverse entry and the differential amplifier exit (AC).

4. Charges reading circuit according to claim 3 characterised by the fact that it contains control material (Mj) of a quiescent current of the differential amplifier (AC) controlled by the comparison signal.

5. Charges reading circuit derived from the detection of radiation by a matrix of N lines by M columns of elementary detectors (ij), the reading device including a total of N×M elementary points (Pij) and charges/voltage conversion points (Aj) each elementary point being linked to an elementary detector and including storage material (Tc) to store the charges detected by the elementary detector to which it is linked and addressing material (Ta) to control the injection in the conversion material the charges stored in the stored material, charges stored in the storage material, the conversion material including a conversion capacity characterised by the fact that an elementary point includes calibration storage material (Tccal) to store a fraction of the stored charges in the storage material and calibration addressing material (Tacal) to control the injection in the conversion material, charges stored in the calibration storage material and in the fact that the conversion material (Aj) includes a first calibration capacity (Ccal) to convert the addressed charges from the calibration storage material (Tccal) into a calibration voltage and material to select the conversion capacity from the calibration voltage.

6. Device according to claim 5, characterised by the fact that the material to select the conversion capacity includes a comparator (K) to deliver a comparison signal (Slog) following the comparison of the calibration voltage with a threshold (Vthreshold) and at least one switch (I2) controlled by the comparison signal to connect a supplementary capacity in parallel with the calibration capacity if the calibration voltage is higher than the threshold voltage such that the conversion capacity is made up of the calibration capacity and the supplementary capacity.

7. Charge reading device according to claim 6 characterised by the fact that the conversion (Aj) includes a differential amplifier (AC) with a reverse entry and an exit, the calibration capacity (Ccal) being mounted between the reverse entry and exit.

8. Charge reading device according to claim 7 characterised by the fact that it contains control material (Mj) with a quiescent current of the differential amplifier (AC).

9. Charge reading process including a charges storage stage, a charges addressing stage and a charges/voltage conversion stage to convert a charges reading in a conversion voltage, the addressing stage enabling control of the injection in charges/voltage conversion (Aj) including a conversion capacity (Ccal) charges stored during the storage stage characterised by the fact that it includes a calibration stage to deliver representative information of the stored charges during the storage stage and a selection stage of the conversion capacity from the said information.

10. Charges reading process according to claim 9 characterised by the fact that the calibration stage includes a calibration storage stage to stock a fraction of charges stored during the storage stage a calibration addressing stage to control the injection in the conversion material (Aj), of the fraction of charges and a conversion stage in a calibration voltage with the help of a calibration capacity (Ccal), of the fraction of charges injected in the conversion material and in the fact that that the selection stage of the conversion capacity includes a comparison stage to deliver comparison signal following the comparison of the calibration voltage with a threshold voltage and a control stage of at least one switch (I2) to connect a supplementary capacity (C) in parallel of the calibration capacity if the calibration voltage is higher than the threshold voltage such that the conversion capacity is constituted from the calibration capacity and of the supplementary capacity.

11. Charges reading process according to claim 10 characterised by the fact that the conversion material including a differential amplifier (AC) includes a control stage of a quiescent current of the differential amplifier controlled by the comparison signal.

12. Charges reading process according to any of the claims 10 or 11 characterised by the fact that it includes a stage to measure the value of a charge read from the conversion voltage measured at the edges of the conversion capacity and of the comparison signal (Slog).

13. Charges reading process derived from the detection of radiation by a matrix of N lines by M columns of elementary detectors the process including a reading stage of charges detected by each elementary detector characterised by the fact that the reading stage of charges detected by each elementary detector is carried out by a process according to claim 9.
